(19) United States
(12) Patent Application Publication
(10) Pub. No.: US 2017/0003853 A1
(43) Pub. Date: Jan. 5, 2017

(54) Vehicle and Method of Controlling the Same

(71) Applicants: Hyundai Motor Company, Seoul (KR); Kia Motors Corporation, Seoul (KR); Hyundai Motor Europe Technical Center GmbH, Russelsheim (DE)

(72) Inventors: Jungsang MIN, Seoul (KR); Sihyun Joo, Seoul (KR); Jeong-Eom Lee, Yongin-si (KR); Gi Beom Hong, Bucheon-si (KR); Andy Max Prill, Russelshelm (DE)

(21) Appl. No.: 14/951,559

(22) Filed: Nov. 25, 2015

(30) Foreign Application Priority Data
Jun. 30, 2015 (KR) 10-2015-0092820

(51) Int. Cl. G06F 3/0481; G06F 3/0484; G06F 3/0482; G06F 3/01; G06F 3/0488

(52) U.S. Cl. CPC G06F 3/04817; G06F 3/017; G06F 3/04883; G06F 3/0482; G06F 3/04845

(57) ABSTRACT

Disclosed herein is a method of controlling a vehicle, including a first displaying operation of displaying a plurality of icons, a gesture recognizing operation of recognizing an input user's gesture, and a second displaying operation of changing the number of icons to be displayed in response to a pinch gesture when the recognized gesture is the pinch gesture.

### CROSS-REFERENCE TO RELATED APPLICATION

This application claims the benefit of priority to Korean Patent Application No. 10-2015-0092820, filed on Jun. 30, 2015, the disclosure of which is incorporated herein by reference.

### FIELD

Embodiments of the present disclosure relate to a vehicle which displays an icon corresponding to a user's gesture, and a method of controlling the same.

### BACKGROUND

The statements in this section merely provide background information related to the present disclosure and may not constitute prior art.

A vehicle has not only a basic traveling function, but also various additional functions for user convenience, such as an audio function, a video function, a navigation function, an air-conditioner controlling function, a sheet controlling function, and a light controlling function.

Such additional functions are established through an interface screen provided in the vehicle, and a user controls the additional functions using various icons displayed through the interface screen.

As the number of icons displayed on the interface screen increases, there is an advantage in that the user may directly access the icons. However, there is also a problem in that an operation for accessing the icons becomes difficult.

Also, a screen image displayed on the interface should be optimized according to the user or traveling situation.

### SUMMARY

Therefore, it is an aspect of the present disclosure to provide a vehicle which is capable of changing a user interface layout using simple gestures, and a method of controlling the same.

Additional aspects of the disclosure will be set forth in part in the description which follows and, in part, will be obvious from the description, or may be learned by practice of the disclosure. In accordance with one aspect of the present disclosure, a vehicle includes a gesture interface configured to receive an input of a user's gesture, a display part configured to display a plurality of icons; and a control part configured to recognize the input user's gesture, and to control the display part to change the number of icons to be displayed when the recognized gesture is a pinch gesture.

The display part may reduce the number of icons to be displayed in response to a pinch-close gesture in which a hand is cupped.

The control part may detect a change in a distance between two fingers, and may recognize as the pinch-close gesture when the distance between the two fingers is reduced.

The control part may detect a change in a size of a gesture space formed by a plurality of fingers, and may recognize as the pinch-close gesture when the size of the gesture space is reduced. And the control part may form the gesture space by connecting end points of the plurality of fingers.

The display part may increase the number of icons to be displayed in response to a pinch-open gesture in which a hand is opened.

The control part may detect a change in a distance between two fingers, and may recognize as the pinch-open gesture when the distance between the two fingers is increased.

The control part may detect a change in a size of a gesture space formed by a plurality of fingers, and may recognize as the pinch-open gesture when the size of the gesture space is increased.

The gesture interface may include a touch interface configured to detect an input of a user's touch, and the control part may detect a change in positions of a plurality of fingers using touch coordinates detected by the touch interface, and may recognize the user's gesture based on the change in the positions of the plurality of fingers. At this time, the touch interface may further include a center point, and the control part may recognize the user's gesture based on a change in a distance between the plurality of fingers and the center point. The control part may recognize as a pinch-close gesture when the distance between the plurality of fingers and the center point is reduced, and may also recognize as a pinch-open gesture when the distance between the plurality of fingers and the center point is increased.

The gesture interface may further include a space interface configured to obtain an image of the user and thus to receive an input of a user's space gesture, and the control part may detect a plurality of fingers from the image, may analyze a change in positions of the plurality of fingers, and may recognize the user's gesture based on the change in the positions of the plurality of fingers.

The display part may change a layout of the plurality of icons to be displayed in response to a multi-rotation gesture in which a hand is rotated. The icon layout may include at least one of colors, shapes, positions, sizes, and arrangements of the plurality of icons.

The touch interface may change a color of emitted light in response to a multi-rotation gesture in which a hand is rotated.

The control part may determine the number of icons to be changed according to a size of the pinch gesture. And the control part may determine the icons to be displayed on the display part according to an order of priority stored in a priority list stored in advance.

In accordance with another aspect of the present disclosure, a method of controlling a vehicle includes a first displaying operation of displaying a plurality of icons, a gesture recognizing operation of recognizing an input user's gesture, and a second displaying operation of changing the number of icons to be displayed in response to a pinch gesture when the recognized gesture is the pinch gesture.

The second displaying operation may include reducing the number of icons to be displayed in response to a pinch-close gesture in which a hand is cupped.

The gesture recognizing operation may include detecting a change in a distance between two fingers, and recognizing as the pinch-close gesture when the distance between the two fingers is reduced.

The gesture recognizing operation may include detecting a size of a gesture space formed by end points of a plurality of fingers, and recognizing as the pinch-close gesture when a size of the gesture space is reduced.

The gesture recognizing operation may include calculating an average distance between a plurality of fingers and a predetermined center point, and recognizing as the pinch-close gesture when the distance between the plurality of fingers and the predetermined center point is reduced.

The second displaying operation may include increasing the number of icons to be displayed in response to a pinch-open gesture in which a hand is opened.

The gesture recognizing operation may include detecting a change in a distance between two fingers, and recognizing as the pinch-open gesture, when the distance between the two fingers is increased.

The gesture recognizing operation may include detecting a size of a gesture space formed by end points of a plurality of fingers, and recognizing as the pinch-open gesture when the size of the gesture space is increased.

The gesture recognizing operation may include calculating an average distance between a plurality of fingers and a predetermined center point, and recognizing as the pinch-open gesture when the distance between the plurality of fingers and the predetermined center point is increased.

The method may further include a third displaying operation of changing a layout of the plurality of icons to be displayed in response to a multi-rotation gesture in which a hand is rotated.

The method may further include changing a color of light of a gesture interface in response to a multi-rotation gesture in which a hand is rotated.

The gesture recognizing operation may include detecting a change in positions of a plurality of fingers using touch coordinates detected by a touch interface.

### DRAWINGS

These and/or other aspects of the disclosure will become apparent and more readily appreciated from the following description of the embodiments, taken in conjunction with the accompanying drawings of which:

FIG. 1 is a view schematically illustrating an exterior of a vehicle;

FIG. 2 is a view schematically illustrating an inside of the vehicle;

FIGS. 3A and 3B are views illustrating an example of an input device included in the vehicle;

FIG. 4 is a control block diagram illustrating an operation of the vehicle;

FIG. 5 is a view illustrating an example of a screen image of a display part included in the vehicle;

FIG. 6 is a view illustrating an example of a priority list;

FIGS. 7A to 7D are views illustrating a pinch-close gesture;

FIGS. 8A to 8D are views illustrating a pinch-open gesture;

FIGS. 9A to 9D are views illustrating a multi-rotation gesture;

FIG. 10 is flowchart illustrating a method of recognizing the pinch-close gesture;

FIG. 11 is a view illustrating a change in touch coordinates according to an input of the pinch-close gesture;

FIG. 12 is a flowchart illustrating a method of recognizing the pinch-close gesture;

FIG. 13 is a view illustrating a change in touch coordinates according to an input of the pinch-close gesture;

FIG. 14 is a flowchart illustrating a method of recognizing the pinch-close gesture;

FIGS. 15A to 15D are views illustrating a change in touch coordinates according to an input of the pinch-close gesture;

FIGS. 16A and 16B are views illustrating a change in a screen image of the display part according to a recognition of the pinch-close gesture;

FIG. 17 is a view illustrating a display controlling method according to the input of the pinch-close gesture;

FIG. 18 is a flowchart illustrating a method of recognizing the pinch-open gesture;

FIG. 19 is a view illustrating a change in touch coordinates according to an input of the pinch-open gesture;

FIG. 20 is a flowchart illustrating a method of recognizing the pinch-open gesture;

FIG. 21 is a view illustrating a change in touch coordinates according to an input of the pinch-open gesture;

FIG. 22 is a flowchart illustrating a method of recognizing the pinch-open gesture;

FIGS. 23A to 23D are views illustrating a change in touch coordinates according to an input of the pinch-open gesture;

FIGS. 24A and 24B are views illustrating a change in the screen image of the display part according to a recognition of the pinch-open gesture;

FIG. 25 is a view illustrating a display controlling method according to the input of the pinch-open gesture;

FIG. 26 is views illustrating a change in the screen image of the display part 200 according to a recognition of rotation gesture;

FIG. 27 is a flowchart illustrating a method of recognizing the pinch-close gesture; and

FIG. 28 is a view illustrating a method of controlling a vehicle 1.

### DETAILED DESCRIPTION

Hereinafter, exemplary embodiments will be described in detail with reference to the accompanying drawings. In the description provided herein, numerous specific details are set forth to help understanding. However, well-known methods, structures and circuits have not been shown in detail in order to not obscure an understanding of this description.

Terms including ordinal numbers such as “first” “second,” etc. can be used to describe various components, but the components are not limited by those terms. The terms are used merely for the purpose of distinguishing one component from another.

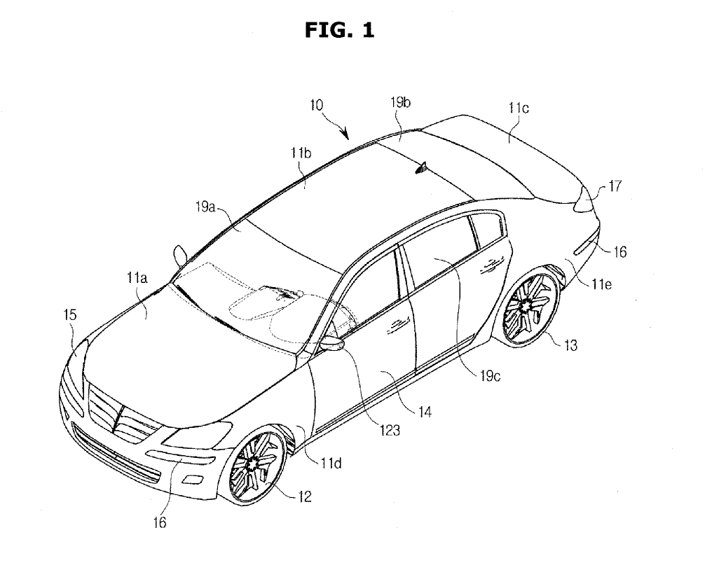

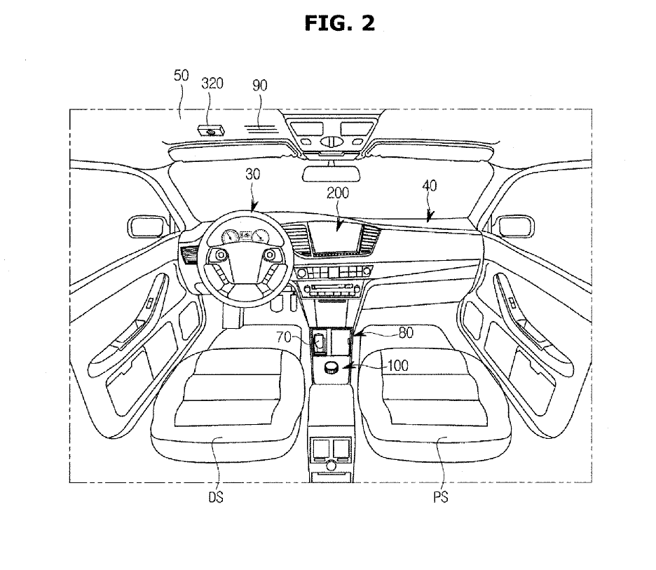

FIG. 1 is a view schematically illustrating an exterior of a vehicle, and FIG. 2 is a view schematically illustrating an inside of the vehicle.

As illustrated in FIG. 1, the vehicle 1 includes a vehicle body which forms an exterior of the vehicle 1, and wheels 12 and 13 which move the vehicle 1.

The vehicle body may include a hood 11a which protects various devices, such as an engine, necessary to operate the vehicle 1, a roof panel 11b which forms an interior space, a trunk lid 11c in which a storage space is provided, and a front fender 11d and a quarter panel 11e which are provided at a side surface of the vehicle 1. Also, a plurality of doors 14 hinge-coupled to the vehicle body 11 may be provided at the side surface of the vehicle body 11.

A front window 19a for providing a front view of the vehicle 1 may be provided between the hood 11a and the roof panel 11b, and a rear window 19b for providing a rear view of the vehicle 1 may be provided between the roof panel 11b and the trunk lid 11c. Also, a side window 19c for providing a side view of the vehicle 1 may be provided at an upper side of each door 14.

Also, a headlamp 15 which emits a light in a direction of movement of the vehicle 1 may be provided at a front side of the vehicle 1.

Also, a turn signal lamp 16 for indicating the direction of movement of the vehicle 1 may be provided at the front and rear sides of the vehicle 1.

Also, a tail lamp 17 may be provided at the rear side of the vehicle 1. The tail lamp 17 is provided at the rear side of the vehicle 1 to indicate a state of a shifting of a gear and a state of operating a brake of the vehicle 1, or the like.

As illustrated in FIG. 2, a driver's seat DS and a passenger seat PS may be provided at an inside of the vehicle 1, and a steering wheel 30 for regulating the moving direction of the vehicle 1, and a dashboard 40 in which various instruments for controlling an operation of vehicle 1 and indicating driving information of the vehicle 1 are also provided.

A voice receiver 90 and a space interface 320 may be provided at a head lining 50 of the driver's seat DS. The voice receiver 90 may include a microphone which converts a user's voice command into an electric signal, and may further include a noise removal filter which removes a noise from a voice input.

A display part 200 may be provided at the center of the dashboard 40. The display part 200 may provide information related to the vehicle 1, an interface for inputting a control command to the vehicle 1, or the like.

Specifically, the display part 200 may provide an interface screen including control icons for controlling each function of the vehicle 1. At this time, an interface screen layout provided at the display part 200 may be changed according to a user's gesture which will be described later.

The display part 200 may be configured with a liquid crystal display (LCD) panel, a light emitting diode (LED) panel, or an organic light emitting diode (OLED) panel, but is not limited thereto.

Meanwhile, FIG. 2 has described an example in which the display part 200 was provided at the dashboard 40. However, this is only an example of an arrangement of the display part 200, and a position of the display part 200 is not limited thereto.

A center console 80 is provided at a lower end of the dashboard 40. The center console 80 is provided between the driver's seat DS and the passenger seat PS, and divides the driver's seat DS and the passenger seat PS.

An arm rest may be provided at a rear side of the center console so that the user of the vehicle 1 rests his/her arm thereon.

Also, an input device 100 for operating various functions of the vehicle 1 may be provided at the center console 80. The user may change settings of the vehicle 1, or may control various equipment for convenience, e.g., an air-conditioner and an audio/video/navigation (AVN) device provided in the vehicle 1 using the input device 100, and a screen image displayed on the display part 200 may be changed by a user's operation of the input device 100.

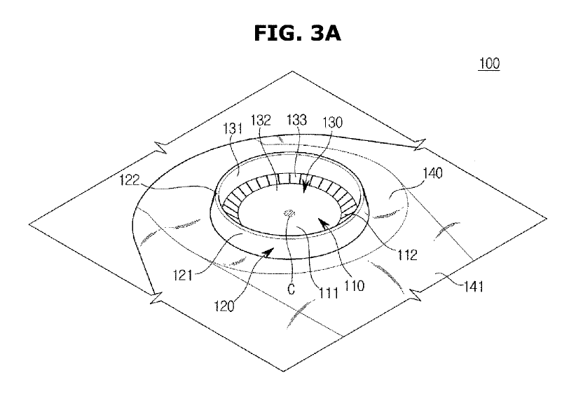

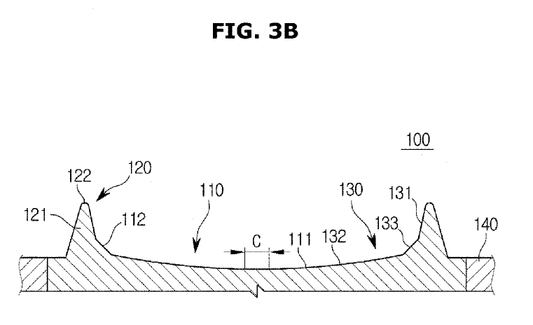

FIGS. 3A to 3B are views illustrating an example of the input device included in the vehicle.

Referring to FIGS. 3A to 3B, the input device 100 includes an installation surface 140, a protruding portion 120 which is installed on the installation surface 140 to protrude from the installation surface 140, and a recessed portion 130 which is formed on an inside of the protruding portion 120 to be recessed. At this time, the protruding portion 120 and the recessed portion 130 may be integrally formed, or may be coupled into one structure, but are not limited thereto.

The installation surface 140 which forms an overall exterior of the input device 100 may be provided separately from the protruding portion 120 and the recessed portion 130, but is not limited thereto.

The installation surface 140 may be provided in an approximately planar shape, but a shape of the installation surface 140 is not limited thereto. For example, the installation surface 140 may be provided in a convex or concave shape.

Meanwhile, although not shown in FIGS. 3A and 3B, the input device 100 may further include other means of input. For example, a push button or a membrane button which inputs the control command may be provided on the installation surface 140, and a toggle switch may be provided on the protruding portion 120 or the recessed portion 130.

The protruding portion 120 may be provided to protrude from the installation surface 140. Specifically, the protruding portion 120 may include an outer side surface 121 connected with the installation surface 140, and a ridge 122 connected with the outer side surface 121.

At this time, the outer side surface 121 is provided between the installation surface 140 and the ridge 122 to have a predetermined curvature, and thus may smoothly connect the installation surface 140 with the ridge 122. However, a shape of the outer side surface 121 is not limited thereto. For example, the outer side surface 121 may be formed in a cylindrical shape.

The ridge 122 may be provided in a shape corresponding to the recessed portion 130, for example, a ring shape. However, the shape of the ridge 122 may be changed according to a shape of a touch interface 310 provided at the input device 100.

The recessed portion 130 is formed to be recessed from the ridge 122 toward the inside of the protruding portion 120. The recessed portion 130 may include a horizontally circular opening in cross section. For example, the recessed portion 130 may be formed to be a recessed circular opening from the ridge 122 inward.

The recessed portion 130 includes an inner side surface 131 connected to the ridge 122, and a bottom 132 in which the touch interface 310 is provided. For example, the drawings illustrate the inner side surface 131 having an inner side shape of a cylinder, and the bottom 132 having a circular planar shape.

Also, the recessed portion 130 may include a connection portion 133 which connects the inner side surface 131 with the bottom 132. For example, the connection portion 133 may be formed in an inclined surface shape or a curved surface shape having a negative curvature. Here, the negative curvature is a curvature which is formed to be concave, when seen from the outside of the recessed portion 130.

At this time, in order for the user to more intuitively perform a touch input, gradations at predetermined intervals may be formed on the connection portion 133. The gradations may be formed in an embossing or engraving method.

When the user inputs a touch gesture through the connection portion 133, the user may further intuitively perform a rolling touch input due to a tactile sensation of the gradations.

As illustrated in FIG. 3B, the bottom 132 may have a downwardly concave shape, but a shape of the touch interface 310 is not limited thereto. For example, the touch interface 310 may have a planar shape, or an upwardly convex shape.

The touch interface 310 is provided on the bottom 132 to assist the user in intuitively performing a control command input. The touch interface 310 will be described later in detail.

The installation surface 140 may further include a wrist support 141 which supports a user's wrist. The wrist support 141 may be located higher than the touch interface 310. Therefore, when the user inputs a gesture on the touch interface 310 using his/her fingers while the wrist is supported on the wrist support 141, the wrist may be prevented from being bent upward. Therefore, musculoskeletal diseases in the user may be prevented, and also a more comfortable feeling of operation may be provided.

FIGS. 3A and 3B have illustrated an example in which the input device 100 has the touch interface 310 having the concave shape. However, the input device 100 is not limited thereto. A variety of devices having the touch interface 310 which may be touched by the user may be used as the input device 100 according to one embodiment of the present disclosure.

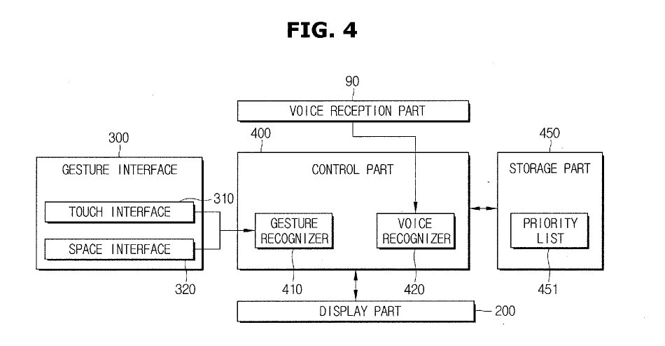

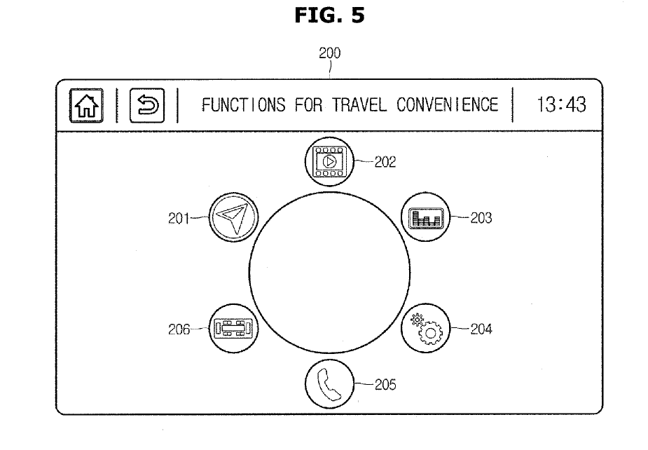

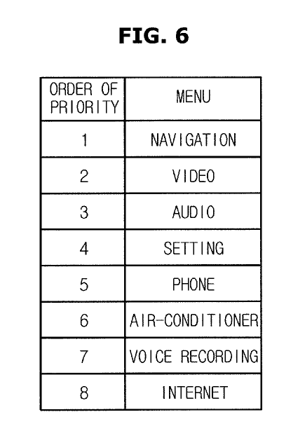

FIG. 4 is a control block diagram illustrating an operation of the vehicle, FIG. 5 is a view illustrating an example of a screen image of the display part included in the vehicle, and FIG. 6 is a view illustrating an example of a priority list.

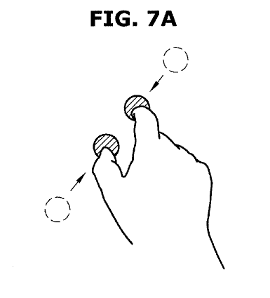

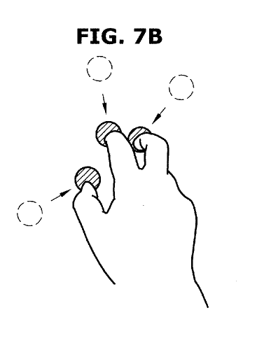

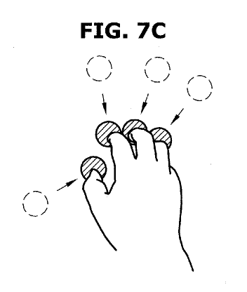

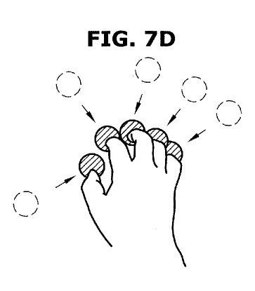

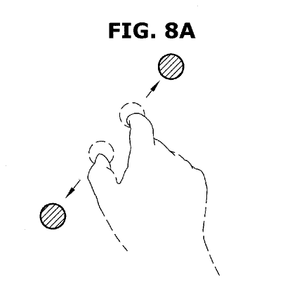

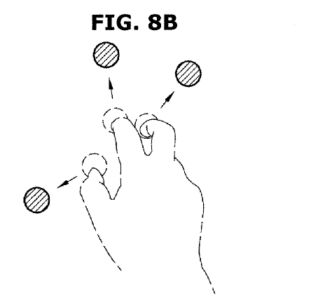

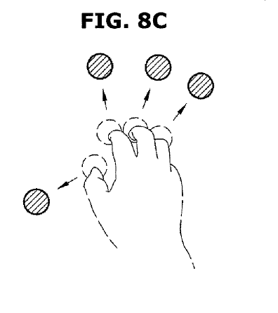

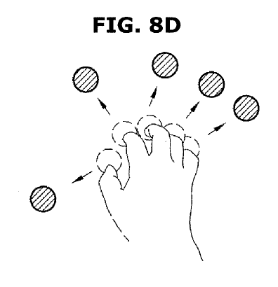

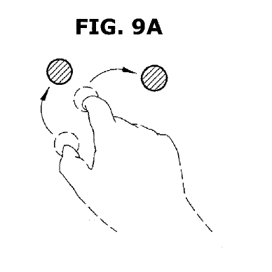

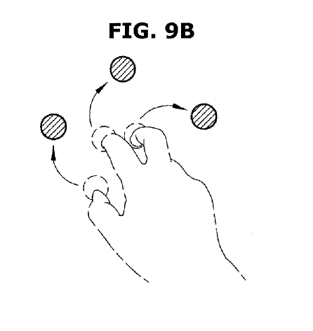

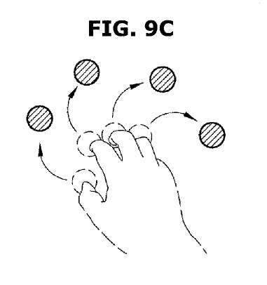

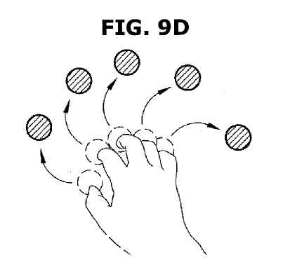

FIGS. 7A to 7D are views illustrating a pinch-close gesture, FIGS. 8A to 8D are views illustrating a pinch-open gesture, and FIGS. 9A to 9D are views illustrating a multi-rotation gesture.

Referring to FIG. 5, the vehicle 1 may include the display part 200, a gesture interface 300 which receives a gesture input from the user, a storage part 450 which stores data necessary to operate the vehicle 1, and a control part 400 which forms a screen image in response to the user's gesture.

The display part 200 may display a screen image which indicates information related to the vehicle 1, and a screen image which establishes a function of the vehicle 1.

As illustrated in FIG. 5, the display part 200 may display a plurality of icons 201 to 206. The user may select the plurality of icons 201 to 206 displayed on the display part 200 to control the vehicle 1.

Specifically, the user may perform a navigation function by selecting a navigation icon 201, or may perform a video function by selecting a video icon 202, or may perform an audio function by selecting an audio icon 203, or may change the settings of the vehicle 1 by selecting a setting icon 204, or may perform a phone connection function by selecting a phone icon 205, or may perform an air-conditioning function by selecting an air-conditioner icon 206.

The number of the icons displayed on the display part 200 may be changed by the user's gesture or the user's voice command. This will be described later in detail.

The storage part 450 may store various data necessary to operate the vehicle 1. For example, the storage part 450 may store an operating system or an application necessary to operate the vehicle 1, and, if necessary, may store temporary data generated by an operation of the control part 400.

Also, the storage part 450 may include a high-speed random access memory, a magnetic disc, an SRAM, a DRAM, a ROM or the like, but is not limited thereto.

Also, the storage part 450 may be detachable from the vehicle 1. For example, the storage part 450 may include a compact flash (CF) card, a secure digital (SD) card, a smart media (SM) card, a multimedia card (MMC) or a memory stick, but is not limited thereto.

Hereinafter, an example in which the storage part 450 and the control part 400 are separately provided will be described. However, the storage part 450 and the control part 400 may be formed in one chip.

Meanwhile, the storage part 450 may further include a priority list 451. As illustrated in FIG. 6, the priority list 451 stores priority information of a menu displayed on the display part 200.

The icons to be displayed on the display part 200 may be determined based on the priority information of the menu stored in the priority list 451. The icons which will be additionally displayed or will be deleted may be determined according to a pinch gesture which will be described later.

The priority information may be established in advance, or may be determined according to a user's pattern of use.

In an example in which the priority information is determined according to a pattern of use, the priority information may be determined according to a user's frequency of use of the menu. That is, as a menu is used more frequently, the menu may have a higher priority. And as a menu is not used frequently, the menu may have a lower priority.

In another example in which the priority information is determined according to the pattern of use, the priority information may be determined according to a history of recent use of the menu. That is, a recently used menu is determined to have a higher priority. And the menu used in the past is determined to have a lower priority.

Since the icons to be displayed on the display part 200 are determined according to the priority information determined by the above-described pattern of use, a user's menu accessibility may be enhanced.

The gesture interface 300 detects a user's gesture input, and generates an electric signal corresponding to the detected gesture. The generated electric signal is transferred to the control part 400.

In other words, the gesture interface 300 may detect the gesture input by the user so that the user may input the control command of the vehicle 1 using the gesture. Specifically, a user interface may detect the user's gesture input, such as flicking, swiping, rolling, circling, spinning and tapping, using his/her fingers.

Also, the gesture interface 300 may detect the gesture input, such as the pinch gesture and a multi-rotation gesture, using a plurality of fingers.

The pinch gesture may be divided into a pinch-close gesture in which a user′ hand is cupped, and a pinch-open gesture in which the user's hand is opened.

The pinch-close gesture is a gesture in which the plurality of fingers are pursed, and may include a pinch-in gesture in which only two fingers are closed as illustrated in FIG. 7A, a gesture in which three fingers are closed as illustrated in FIG. 7B, a gesture in which four fingers are closed as illustrated in FIG. 7C, and a gesture in which five fingers are closed as illustrated in FIG. 7D.

The pinch-open gesture is a gesture in which the plurality of fingers are opened, and may include a pinch-out gesture in which only two fingers are opened as illustrated in FIG. 8A, a gesture in which three fingers are opened as illustrated in FIG. 8B, a gesture in which four fingers are opened as illustrated in FIG. 8C, and a gesture in which five fingers are opened as illustrated in FIG. 8D.

The multi-rotation gesture is a gesture in which the plurality of fingers rotate, and may include a gesture in which only two fingers rotate as illustrated in FIG. 9A, a gesture in which three fingers rotate as illustrated in FIG. 9B, a gesture in which four fingers rotate as illustrated in FIG. 9C, and a gesture in which five fingers rotate as illustrated in FIG. 9D.

Referring to FIG. 4 again, to detect the gesture, the gesture interface 300 may include the touch interface 310 which detects a user's touch gesture, and a space interface 320 which detects a user's space gesture.

The touch interface 310 detects the user's touch gesture, and outputs an electric signal corresponding to the detected touch gesture. As illustrated in FIGS. 3A and 3B, the touch interface 310 may be provided on the bottom 132 of the input device 100. The touch interface 310 may be provided to have a predetermined curvature along the bottom of the input device 100. That is, the touch interface 310 may be provided to have the concave shape according to the shape of the bottom 132.

At this time, the most concave point of the touch interface 310 is referred to as a center point C. The center point C may be used as a gesture recognition reference. This will be described later in detail.

Meanwhile, a position of the touch interface 310 is not limited to the bottom 132. For example, the touch interface 310 may also be provided at the connection portion 133 to detect the touch gesture input to the connection portion 133.

Also, the touch interface 310 may be integrally provided with the display part 200. Specifically, the touch interface 310 may be realized in an add-on type which is located on a screen of the display part 200, or an on-cell type or an in-cell type which is located in the display part 200.

Also, the touch interface 310 may include a touch panel for detecting a user's touch. The touch panel may include a resistive type, an optical type, a capacitive type, an ultrasonic type, and a pressure type which may recognize a user's proximity or touch, but is not limited thereto.

The touch panel generates an electric signal corresponding to the touch, and then transfers the electric signal to a gesture recognizer 410. Specifically, when a touch event occurs, the touch panel may detect touch coordinates corresponding to an area in which the touch event occurs, and then may transfer the detected touch coordinates to the gesture recognizer 410.

Meanwhile, the space interface 320 detects a user's input through a gesture in a space, and outputs an electric signal corresponding to the detected space gesture. Specifically, the space interface 320 may obtain an image of the user, and then may transfer the obtained image to the gesture recognizer 410.

As illustrated in FIG. 2, the space interface 320 may be disposed on a head lining 50, but a position of the space interface 320 is not limited thereto. For example, the space interface 320 may be disposed on the dashboard or the center console 80.

The space interface 320 may include at least one camera which detects the input through the gesture in the space by the user. Here, the camera may include a charge-couple device (CCD) or a complementary metal-oxide-semiconductor (CMOS) phototransistor, and may receive light projected through one or more lenses, and may obtain an image.

Also, the space interface 320 may be realized with a stereo camera to obtain a three-dimensional image.

Also, to clearly recognize the user's hand, the space interface 320 may obtain an infrared image. To this end, the space interface 320 may include an infrared light source which emits infrared light toward the user, and an infrared camera which obtains an image of an infrared area.

The control part 400 may recognize the user's gesture, and may generally control the vehicle 1 according to the recognized gesture. The control part 400 may correspond to one or a plurality of processors.

At this time, the processor may be realized with an array of a plurality of logic gates, or may be realized with a combination of memories in which programs executed in a microprocessor are stored. For example, the control part 400 may be realized with a micro-controller unit (MCU), or a general-purpose processor such as a central processing unit (CPU) and a graphic processing unit (GPU).

Also, the control part 400 may control each function of the vehicle 1 according to the user's gesture input through the gesture interface 300, or the user's voice command input through the voice receiver 90. That is, the user may control the vehicle 1 through the input of the voice command and the gesture.

Also, the control part 400 may include a voice recognizer 420 which recognizes the user's voice command and performs a function corresponding to the recognized voice command, and the gesture recognizer 410 which recognizes the user's gesture and performs a function corresponding to the recognized gesture.

The voice recognizer 420 recognizes the voice command input through the voice receiver 90, and performs the function corresponding to the recognized voice command. To recognize the voice command, a well-known voice recognition algorithm or voice recognition engine may be used, and other voice recognition algorithms or voice recognition engines which will be developed later according to development of technology may also be applied.

The gesture recognizer 410 recognizes the user's gesture, and controls the functions of the vehicle 1 according to the recognized gesture. Also, the gesture recognizer 410 may control a display of the screen image of the display part 200 according to the recognized user's gesture.

Specifically, the gesture recognizer 410 may analyze a change in positions of the user's fingers based on the user's gesture detected through the gesture interface 300, and may recognize the user's gesture based on the analyzed change in the positions of the user's fingers.

Here, a method of analyzing the change in the positions of the fingers may be changed according to a type of the gesture interface 300.

Specifically, when the gesture interface 300 is the touch interface 310, the touch coordinates detected by the touch interface 310 correspond to coordinates of points touched by the user's fingers, and thus the gesture recognizer 410 may determine a start and a finish of the user's touch based on whether or not the touch coordinates are detected, and may analyze the change in the positions of the fingers by tracking a moving trajectory of the touch coordinates.

Meanwhile, when the gesture interface 300 is the space interface 320, the gesture recognizer 410 may detect a palm and end points of the fingers from an image taken by the space interface 320, and may analyze the change in the positions of the fingers by tracking a change in positions of the palm and the end points of the fingers.

The gesture recognizer 410 may recognize the gesture input by the user based on the analyzed change in the positions of the fingers, and may perform the function corresponding to the recognized gesture.

Specifically, the gesture recognizer 410 may recognize the pinch-close gesture illustrated in FIGS. 7A to 7D. Hereinafter, a method of recognizing the pinch-close gesture will be described in detail.

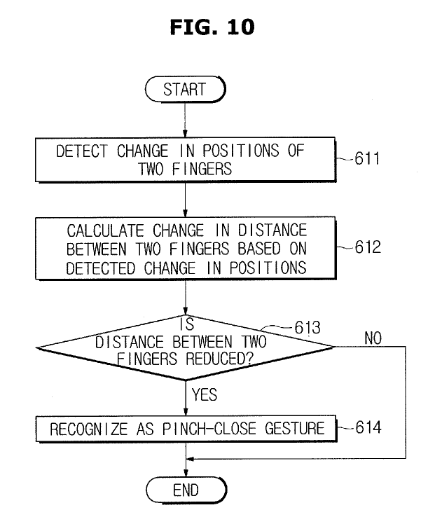

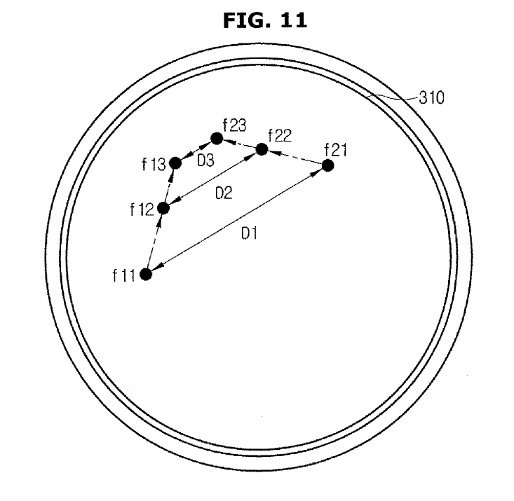

FIG. 10 is flowchart illustrating the method of recognizing the pinch-close gesture, and FIG. 11 is a view illustrating the change in the touch coordinates according to the input of the pinch-close gesture.

In one embodiment, the gesture recognizer 410 may recognize the input of the pinch-close gesture using a change in a distance between the fingers.

Referring to FIGS. 10 and 11, the vehicle 1 detects a change in positions of two fingers (S611). When the user inputs the pinch-close gesture to the touch interface 310 using the two fingers, as illustrated in FIG. 7A, the touch coordinates are changed as illustrated in FIG. 11. Since the change of the touch coordinates corresponds to the change in the positions of the two fingers, the gesture recognizer 410 may detect the change in the positions of the two fingers according to the change in the touch coordinates.

The vehicle 1 calculates the change in the distance between the two fingers based on the detected change in the positions (S612). The gesture recognizer 410 may intermittently calculate the change in the distance between the two fingers.

As described above, since the positions of the two fingers correspond to the touch coordinates, the gesture recognizer 410 may calculate a distance D1 between the touch coordinates f11 and f21 at the start of the touch as a distance between the two fingers at the start of the touch, may calculate a distance D2 between the touch coordinates f12 and f22 after a predetermined time interval as a distance between the two fingers after the predetermined time interval, and may calculate a distance D3 between the touch coordinates f13 and f23 at the finish of the touch as a distance between the two fingers at the finish of the touch.

Meanwhile, unlike FIG. 11, the gesture recognizer 410 may calculate the change in the distance between the two fingers sequentially.

The vehicle 1 determines whether or not the distance between the two fingers is reduced (S613). The gesture recognizer 410 may determine whether or not the distance between the two fingers is reduced based on the change in the distance between the two fingers. Specifically, when the distance between the two fingers is reduced in the order of D1, D2, and D3 over time, the gesture recognizer 410 determines that the distance between the two fingers is reduced.

Meanwhile, in the case in which the calculation of the change in the distance between the two fingers is performed continuously, when the continuously calculated distance between the two fingers is changed so as to reduce, the gesture recognizer 410 determines that the distance between the two fingers is reduced.

When the distance between the two fingers is reduced (YES in operation S613), the vehicle 1 may recognize the gesture input as the pinch-close gesture (S614).

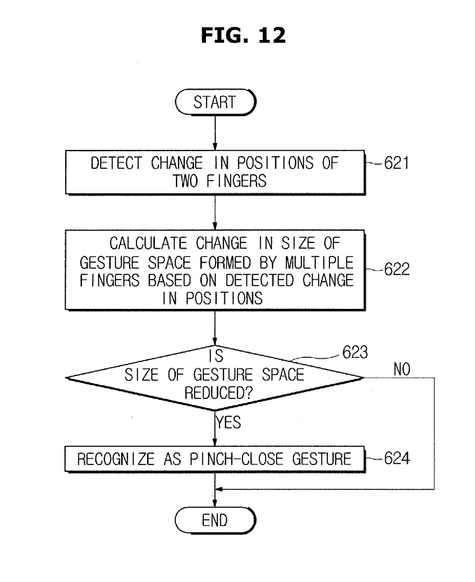

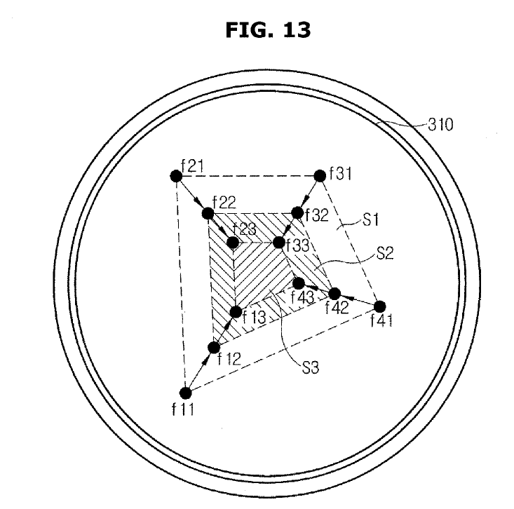

FIG. 12 is a flowchart illustrating a method of recognizing the pinch-close gesture, and FIG. 13 is a view illustrating the change in the touch coordinates according to the input of the pinch-close gesture.

In another embodiment, the gesture recognizer 410 may recognize the input of the pinch-close gesture using a change in a size of a gesture space formed by the plurality of fingers. Here, the gesture space is a virtual space which is formed by connecting end points of three or more fingers.

Referring to FIGS. 12 and 13, the vehicle 1 detects a change in positions of the fingers (S621). When the user inputs the pinch-close gesture on the touch interface 310 using four fingers, as illustrated in FIG. 7C, the touch coordinates are changed as illustrated in FIG. 13. Since the change in the touch coordinates corresponds to the change in the positions of the fingers, the gesture recognizer 410 may detect the change in the positions of the fingers according to the change in the touch coordinates.

The vehicle 1 calculates the change in the size of the gesture space formed by the plurality of fingers based on the detected change in the positions (S622). The gesture recognizer 410 may intermittently calculate the change in the size of the gesture space formed by the plurality of fingers.

As described above, since the positions of the fingers correspond to the touch coordinates, the gesture recognizer 410 may calculate a gesture space S1 at the start of the touch by connecting a plurality of touch coordinates f11, f21, f31, and f41 at the start of the touch, may calculate a gesture space S2 after a predetermined time interval by connecting a plurality of touch coordinates f12, f22, f32, and f42 after the predetermined time interval, and may calculate a gesture space S3 at the finish of the touch by connecting a plurality of touch coordinates f13, f23, f33, and f43 at the finish of the touch, as illustrated in FIG. 13.

Meanwhile, unlike FIG. 13, the gesture recognizer 410 may continuously calculate the gesture space.

The vehicle 1 determines whether or not the size of the gesture space is reduced (S623). The gesture recognizer 410 may determine whether or not the size of the gesture space is reduced by comparing the size of the gesture space calculated over time sequentially. Specifically, when the size of the gesture space is reduced in the order of S1, S2, and S3 over time, the gesture recognizer 410 determines that the size of the gesture space is reduced.

Meanwhile, in the case in which the calculation of the size of the gesture space is performed continuously, when the continuously calculated size of the gesture space is changed so as to be smaller than a predetermined reference, the gesture recognizer 410 determines that the size of the gesture space is reduced.

When the size of the gesture space is reduced (YES in operation S623), the vehicle 1 may recognize the gesture input as the pinch-close gesture (S624).

Meanwhile, FIG. 13 has described the method of recognizing the pinch-close gesture using the four fingers. However, even in the case that three fingers or more than four fingers are touching, it would be obvious to a person skilled in the art that whether or not the size of the gesture space is reduced may be determined by the same method, and thus the pinch-close gesture may be recognized.

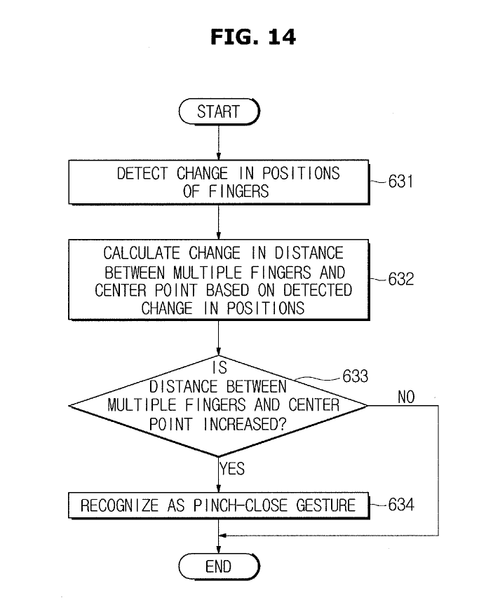

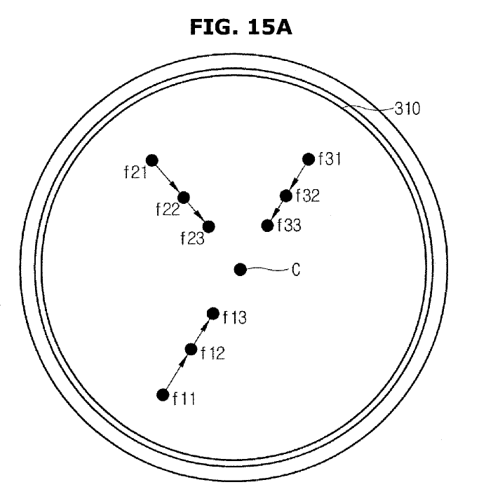

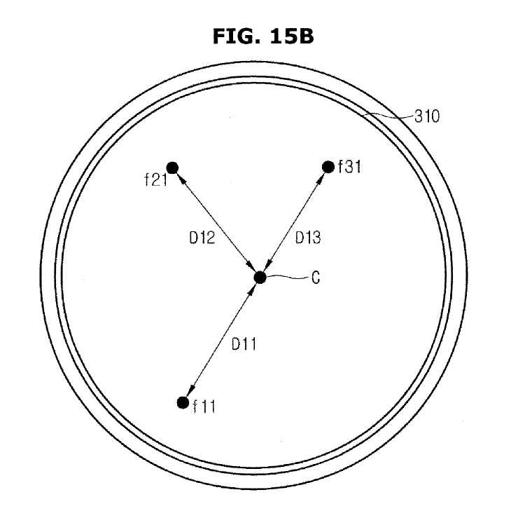

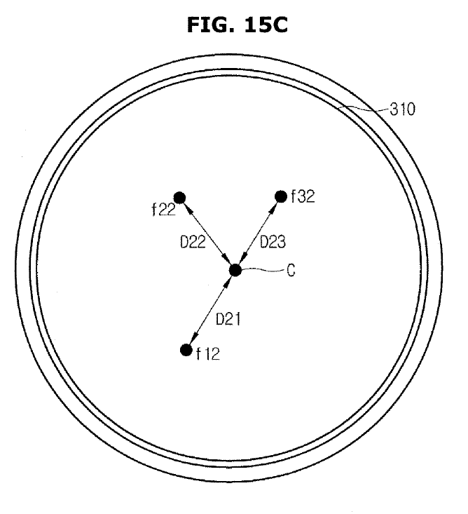

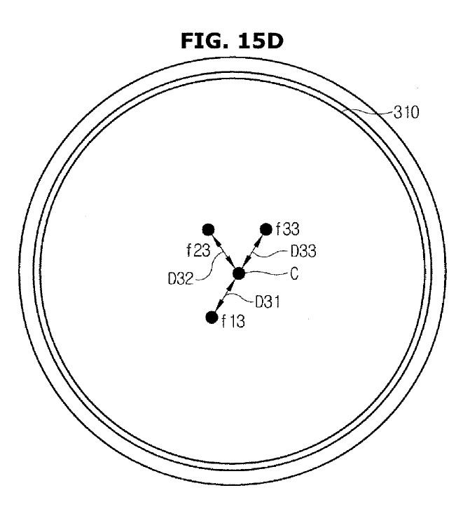

FIG. 14 is a flowchart illustrating a method of recognizing the pinch-close gesture, and FIGS. 15A to 15D are views illustrating the change in the touch coordinates according to the input of the pinch-close gesture.

In the still another embodiment, the gesture recognizer 410 may recognize the input of the pinch-close gesture using a change in a distance between the predetermined center point C and the fingers.

Referring to FIGS. 14 and 15A to 15D, the vehicle 1 detects a change in positions of the fingers (S631). When the user inputs the pinch-close gesture on the touch interface 310 using three fingers, as illustrated in FIG. 7B, the touch coordinates are changed as illustrated in FIG. 15A. Since the change in the touch coordinates corresponds to the change in the positions of the three fingers, the gesture recognizer 410 may detect the change in the positions of the three fingers according to the change in the touch coordinates.

The vehicle 1 calculates the change in the distance between the plurality of fingers and the center point C based on the detected change in the positions between the plurality of fingers and the center point C (S632). The gesture recognizer 410 may intermittently calculate the change in the distance between the plurality of fingers and the center point C.

As described above, since the positions of the fingers correspond to the touch coordinates, the gesture recognizer 410 may calculate an average value D1 of the distances D11, D12 and D13 between the plurality of touch coordinates f11, f21 and f31 and the center point C at the start of the touch, as illustrated in FIG. 15B, may calculate an average value D2 of the distances D21, D22 and D23 between the plurality of touch coordinates f12, f22 and f32 and the center point C after a predetermined time interval, as illustrated in FIG. 15C, and may calculate an average value D3 of the distances D31, D32 and D33 between the plurality of touch coordinates f13, f23 and f33 and the center point C at the finish of the touch, as illustrated in FIG. 15D.

Meanwhile, unlike FIGS. 15A to 15D, the gesture recognizer 410 may calculate the change in the distance between the plurality of fingers and the center point C sequentially.

The vehicle 1 determines whether or not the distance between the plurality of fingers and the center point C is reduced (S633). When the distance between the plurality of fingers and the center point C is reduced in the order of D1, D2, and D3 over time, the gesture recognizer 410 determines that the distance between the plurality of fingers and the center point C is reduced.

Meanwhile, in the case in which the calculation of the change in the distance between the plurality of fingers and the center point C is performed continuously, when the continuously calculated distance between the plurality of fingers and the center point C is changed so as to be shorter than a predetermined reference, the gesture recognizer 410 determines that the distance between the plurality of fingers and the center point C is reduced.

When the distance between the plurality of fingers and the center point C is reduced (YES in operation S633), the vehicle 1 may recognize the gesture input as the pinch-close gesture (S634).

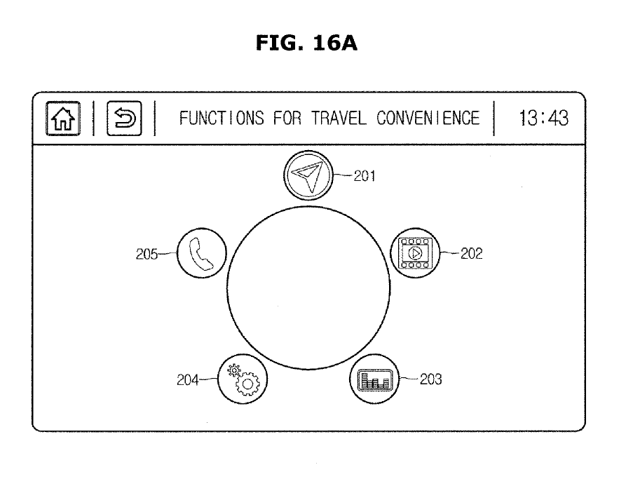

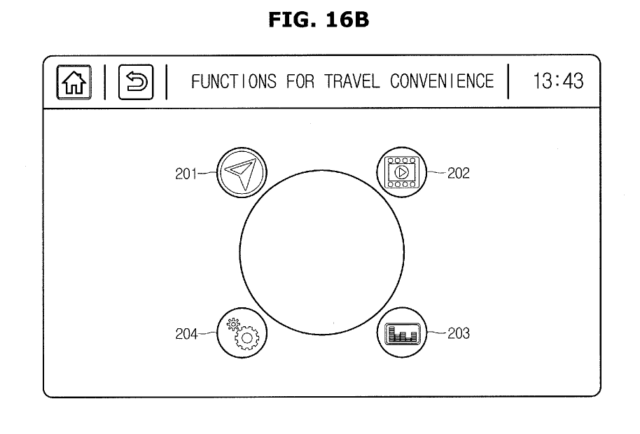

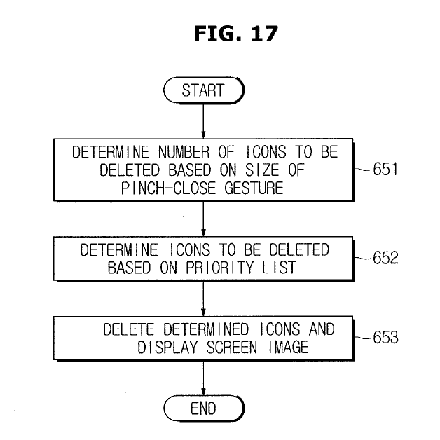

FIGS. 16A and 16B are views illustrating a change in a screen image of the display part 200 according to a recognition of the pinch-close gesture, and FIG. 17 is a view illustrating a display controlling method according to the input of the pinch-close gesture.

When the gesture input by the user is recognized as the pinch-close gesture, the gesture recognizer 410 may control the display part 200 in response to the pinch-close gesture so that the number of icons displayed on the display part 200 is reduced.

That is, in a state in which six icons are displayed, as illustrated in FIG. 5, when the pinch-close gesture is input, the number of icons displayed on the display part 200 is reduced as illustrated in FIGS. 16A and 16B.

At this time, the number of displayed icons may be determined according to a size of the pinch-close gesture. For example, when the size of the pinch-close gesture is smaller than a threshold, five icons 201 to 205 may be displayed, as illustrated in FIG. 16A, and when the size of the pinch-close gesture is larger than the threshold, four icons 201 to 204 are displayed, as illustrated in FIG. 16B.

Also, the icons which will not be displayed on the display part 200 may be determined according to the priority information of the predetermined priority list 451.

Hereinafter, the display controlling method according to the pinch-close gesture will be described in detail with reference to FIG. 17.

Referring to FIG. 17, the vehicle 1 determines the number of icons to be deleted based on the size of the pinch-close gesture (S651). The gesture recognizer 410 may calculate the size of the pinch-close gesture, and may determine the number of icons to be deleted according to the size of the calculated pinch-close gesture. A method of calculating the size of the pinch-close gesture may be changed according to the method of recognizing the pinch-close gesture.

For example, as illustrated in FIG. 11, when the pinch-close gesture is recognized based on the distance between the two fingers, as a rate of reduction in the distance between the two fingers becomes higher, the determination of the pinch-close gesture becomes larger.

Also, as illustrated in FIG. 13, when the pinch-close gesture is recognized based on a reduction in the size of the gesture space, the higher a rate of reduction in the size of the gesture space becomes, the larger a determination of the pinch-close gesture becomes.

Also, as illustrated in FIGS. 15A to 15D, when the pinch-close gesture is recognized based on the distance between the plurality of fingers and the center point C, the higher a rate of reduction of the plurality of fingers to the center point C becomes, the larger the determination of the pinch-close gesture becomes.

The vehicle 1 determines the icon to be deleted based on the priority list (S652). The icon to be deleted is determined according to the predetermined priority. That is, the icon corresponding to the menu having the low priority is deleted first.

For example, when the priority list 451 is set as illustrated in FIG. 6, the icons to be deleted are determined in an order of an air-conditioner icon 206 and a phone icon 205 according to the priority of the menu.

The vehicle 1 displays the screen image, while the determined icon is deleted (S653). For example, when one icon is deleted, the air-conditioner icon 206 is deleted as illustrated in FIG. 16A, and a navigation icon 201, a video icon 202, an audio icon 203, a setting icon 204, and the phone icon 205 are displayed.

Also, when two icons are deleted, the air-conditioner icon 206 and the phone icon 205 are deleted as illustrated in FIG. 16B, and the navigation icon 201, the video icon 202, the audio icon 203, and the setting icon 204 are displayed.

Meanwhile, a size or an arrangement of the icon may be controlled in response to the deleting of the icon.

Meanwhile, the gesture recognizer 410 may recognize the pinch-open gesture illustrated in FIGS. 8A to 8D. Hereinafter, a method of recognizing the pinch-open gesture will be described in detail.

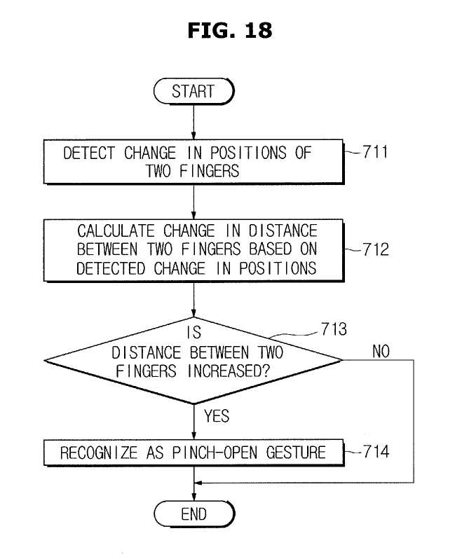

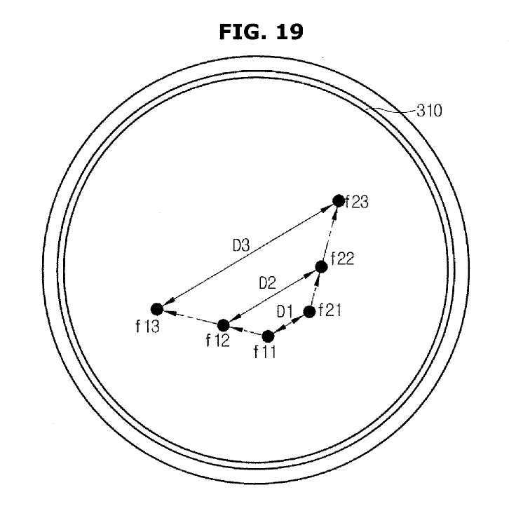

FIG. 18 is a flowchart illustrating the method of recognizing the pinch-open gesture, and FIG. 19 is a view illustrating a change in the touch coordinates according to the input of the pinch-open gesture.

In one embodiment, the gesture recognizer 410 may recognize the input of the pinch-open gesture using a change in a distance between the fingers.

Referring to FIGS. 18 and 19, the vehicle 1 detects a change in positions of two fingers (S711). When the user inputs the pinch-open gesture on the touch interface 310 using the two fingers, as illustrated in FIG. 8A, the touch coordinates are changed as illustrated in FIG. 19. Since the change of the touch coordinates corresponds to the change in the positions of the two fingers, the gesture recognizer 410 may detect the change in the positions of the two fingers according to the change in the touch coordinates.

The vehicle 1 calculates the change in the distance between the two fingers based on the detected change in the positions of the two fingers (S712). The gesture recognizer 410 may intermittently calculate the change in the distance between the two fingers.

As described above, since the positions of the two fingers correspond to the touch coordinates, the gesture recognizer 410 may calculate a distance D1 between the touch coordinates f11 and f21 at the start of the touch as a distance between the two fingers at the start of the touch, may calculate a distance D2 between the touch coordinates f12 and f22 after a predetermined time interval as a distance between the two fingers after the predetermined time interval, and may calculate a distance D3 between the touch coordinates f13 and f23 at the finish of the touch as a distance between the two fingers at the finish of the touch.

Meanwhile, unlike FIG. 19, the gesture recognizer 410 may calculate the change in the distance between the two fingers sequentially.

The vehicle 1 determines whether or not the distance between the two fingers is increased (S713). The gesture recognizer 410 may determine whether or not the distance between the two fingers is increased based on the change in the distance between the two fingers. Specifically, when the distance between the two fingers is increased in the order of D1, D2, and D3 over time, the gesture recognizer 410 determines that the distance between the two fingers is increased.

Meanwhile, in the case in which the calculation of the change in the distance between the two fingers is performed continuously, when the continuously calculated distance between the two fingers is changed so as to increase, the gesture recognizer 410 determines that the distance between the two fingers is increased.

When the distance between the two fingers is increased (YES in operation S713), the vehicle 1 may recognize the gesture input as the pinch-open gesture (S714).

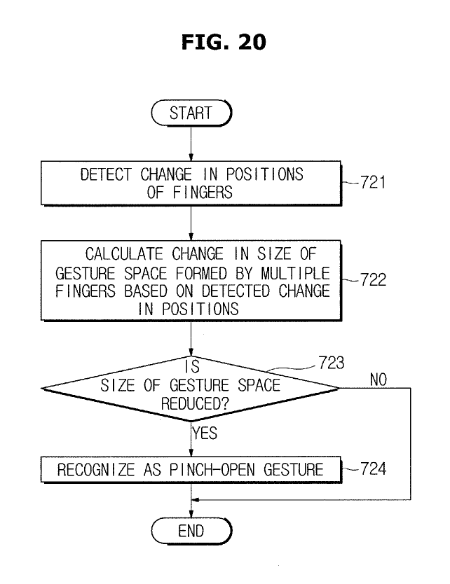

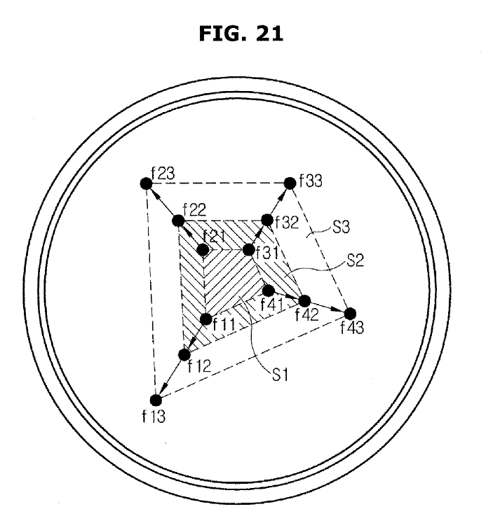

FIG. 20 is a flowchart illustrating a method of recognizing the pinch-open gesture, and FIG. 21 is a view illustrating a change in the touch coordinates according to the input of the pinch-open gesture.

In another embodiment, the gesture recognizer 410 may recognize the input of the pinch-open gesture using a change in a size of a gesture space formed by a plurality of fingers.

Referring to FIGS. 20 and 21, the vehicle 1 detects a change in positions of the fingers (S721). When the user inputs the pinch-open gesture on the touch interface 310 using four fingers, as illustrated in FIG. 8C, the touch coordinates are changed as illustrated in FIG. 21. Since the change in the touch coordinates corresponds to the change in the positions of the fingers, the gesture recognizer 410 may detect the change in the positions of the fingers according to the change in the touch coordinates.

The vehicle 1 calculates the change in the size of the gesture space formed by the plurality of fingers based on the detected change in the positions of the plurality of fingers (S722). The gesture recognizer 410 may intermittently calculate the change in the size of the gesture space formed by the plurality of fingers.

As described above, since the positions of the fingers correspond to the touch coordinates, the gesture recognizer 410 may calculate a gesture space S1 at the start of the touch by connecting a plurality of touch coordinates f11, f21, f31, and f41 at the start of the touch, may calculate a gesture space S2 after a predetermined time interval by connecting a plurality of touch coordinates f12, f22, f32, and f42 after the predetermined time interval, and may calculate a gesture space S3 at the finish of the touch by connecting a plurality of touch coordinates f13, f23, f33, and f43 at the finish of the touch, as illustrated in FIG. 21.

Meanwhile, unlike FIG. 21, the gesture recognizer 410 may calculate the gesture space sequentially.

The vehicle 1 determines whether or not the size of the gesture space is increased (S723). The gesture recognizer 410 may determine whether or not the size of the gesture space is increased by comparing the size of the gesture space calculated over time sequentially. Specifically, when the size of the gesture space is increased in the order of S1, S2, and S3 over time, the gesture recognizer 410 determines that the size of the gesture space is increased.

Meanwhile, in the case in which the calculation of the size of the gesture space is performed continuously, when the continuously calculated size of the gesture space is changed so as to be larger than a predetermined reference, the gesture recognizer 410 determines that the size of the gesture space is increased.

When the size of the gesture space is increased (YES in operation S723), the vehicle 1 may recognize the gesture input as the pinch-open gesture (S724).

Meanwhile, FIG. 21 has described the method of recognizing the pinch-open gesture using the four fingers. However, even in the case that three fingers or more than four fingers are touching, it would be obvious to a person skilled in the art that whether or not the size of the gesture space is increased may be determined by the same method, and thus the pinch-open gesture may be recognized.

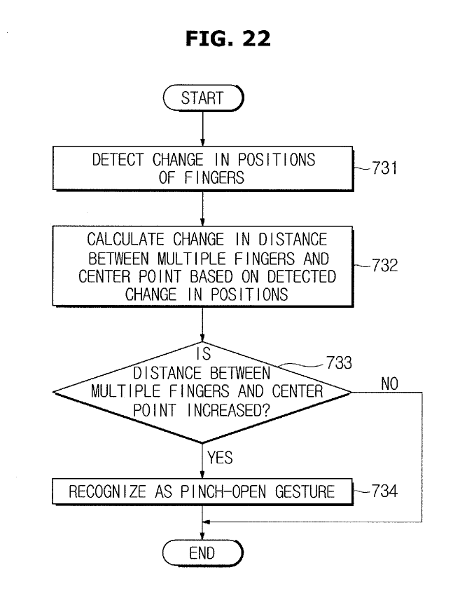

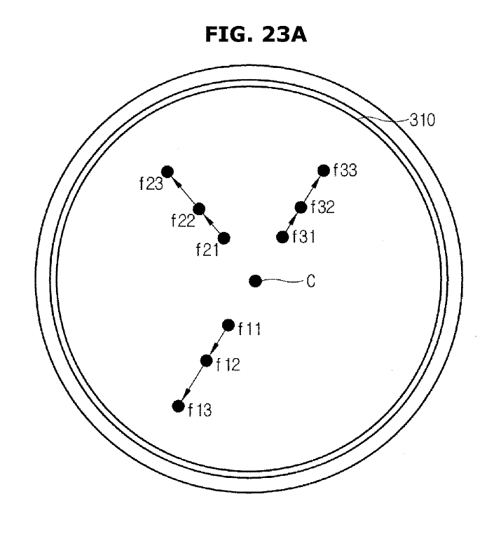

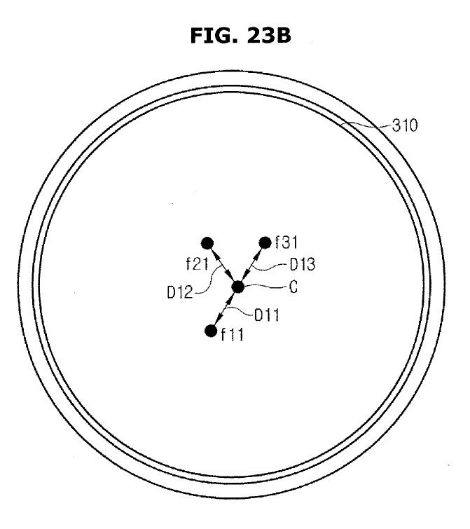

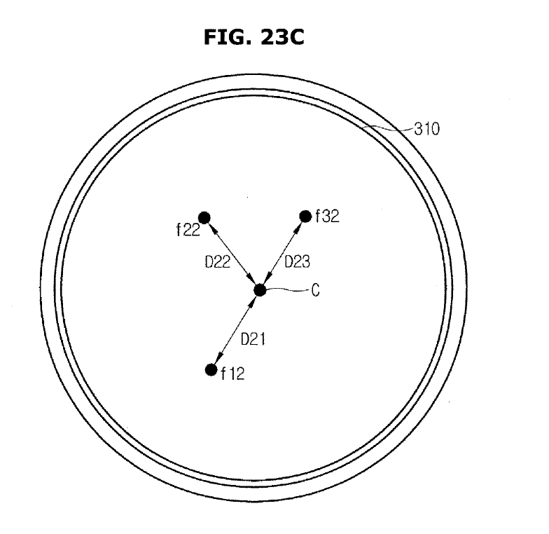

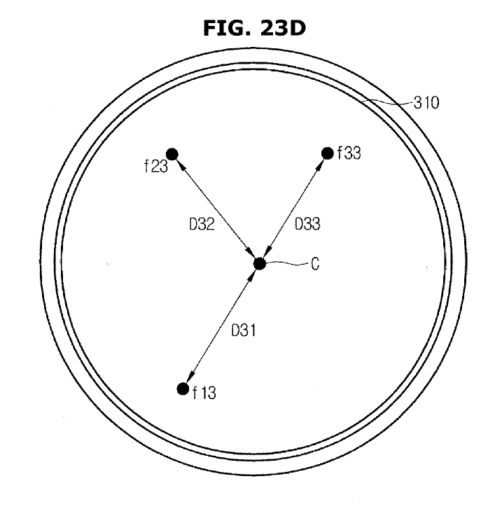

FIG. 22 is a flowchart illustrating a method of recognizing the pinch-open gesture, and FIGS. 23A to 23D is a view illustrating a change in the touch coordinates according to the input of the pinch-open gesture.

The gesture recognizer 410 may recognize the input of the pinch-open gesture using a change in a distance between a center point C and the fingers.

Referring to FIGS. 22 and 23A to 23D, the vehicle 1 detects a change in positions of the fingers (S731). When the user inputs the pinch-open gesture on the touch interface 310 using three fingers, as illustrated in FIG. 8B, the touch coordinates are changed as illustrated in FIG. 23A. Since the change in the touch coordinates corresponds to the change in the positions of the three fingers, the gesture recognizer 410 may detect the change in the positions of the three fingers according to the change in the touch coordinates.

The vehicle 1 calculates the change in the average distance between a plurality of fingers and the center point C based on the detected change in the positions of the plurality of fingers and the center point C (S732). The gesture recognizer 410 may intermittently calculate the change in the distance between the plurality of fingers and the center point C.

As described above, since the positions of the fingers correspond to the touch coordinates, the gesture recognizer 410 may calculate an average value D1 of the distances D11, D12 and D13 between the plurality of touch coordinates f11, f21 and f31 and the center point C at the start of the touch, as illustrated in FIG. 23B, may calculate an average value D2 of the distances D21, D22 and D23 between the plurality of touch coordinates f12, f22 and f32 and the center point C after a predetermined time interval, as illustrated in FIG. 23C, and may calculate an average value D3 of the distances D31, D32 and D33 between the plurality of touch coordinates f13, f23 and f33 and the center point C at the finish of the touch, as illustrated in FIG. 23D.

Meanwhile, unlike FIG. 23, the gesture recognizer 410 may calculate the change in the distance between the plurality of fingers and the center point C sequentially.

The vehicle 1 determines whether or not the distance between the plurality of fingers and the center point C is increased (S733). When the distance between the plurality of fingers and the center point C is increased in the order of D1, D2, and D3 over time, the gesture recognizer 410 determines that the distance between the plurality of fingers and the center point C is increased.

Meanwhile, in the case in which the calculation of the change in the distance between the plurality of fingers and the center point C is performed continuously, when the continuously calculated distance between the plurality of fingers and the center point C is changed so as to increase past a predetermined reference, the gesture recognizer 410 determines that the distance between the plurality of fingers and the center point C is increased.

When the distance between the plurality of fingers and the center point C is increased (YES in operation S733), the vehicle 1 may recognize the gesture input as the pinch-open gesture (S734).

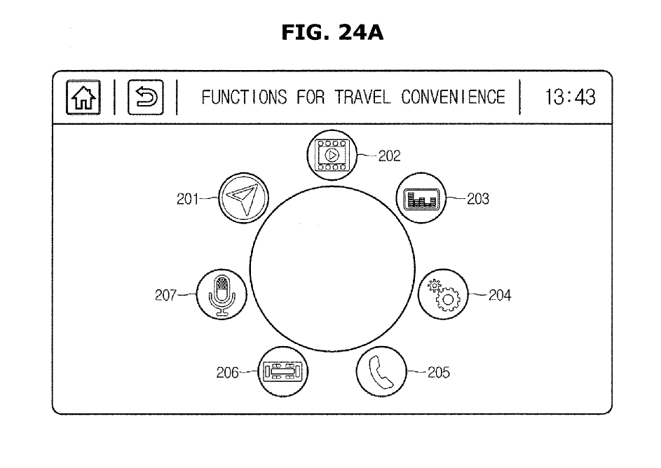

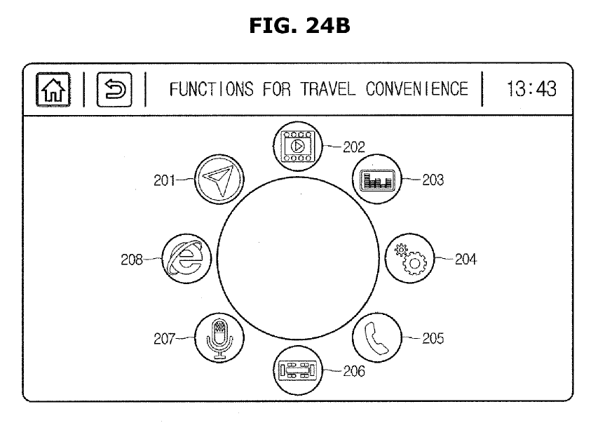

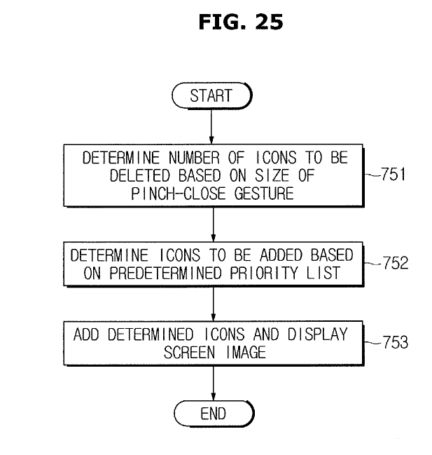

FIGS. 24A and 24B are views illustrating a change in the screen image of the display part according to recognition of the pinch-open gesture, and FIG. 25 is a view illustrating the display controlling method according to the input of the pinch-open gesture.

When the gesture input by the user is recognized as the pinch-open gesture, the gesture recognizer 410 may control the display part 200 in response to the pinch-open gesture so that the number of icons displayed on the display part 200 is increased.

That is, in a state in which six icons are displayed, as illustrated in FIG. 5, when the pinch-open gesture is input, the number of icons displayed on the display part 200 is increased as illustrated in FIGS. 24A and 24B.

At this time, the number of displayed icons may be determined according to a size of the pinch-open gesture. For example, when the size of the pinch-open gesture is smaller than a threshold, seven icons 201 to 207 may be displayed, as illustrated in FIG. 24A, and when the size of the pinch-open gesture is larger than the threshold, eight icons 201 to 208 are displayed, as illustrated in FIG. 24B.

Also, the icons which will be additionally displayed on the display part 200 may be determined according to the priority information of the predetermined priority list 451.

Hereinafter, the display controlling method according to the pinch-open gesture will be described in detail with reference to FIG. 25.

Referring to FIG. 25, the vehicle 1 determines the number of icons to be added based on the size of the pinch-open gesture (S751). The gesture recognizer 410 may calculate the size of the pinch-open gesture, and may determine the number of icons to be added according to the size of the calculated pinch-open gesture. A method of calculating the size of the pinch-open gesture may be changed according to the method of recognizing the pinch-open gesture.

For example, as illustrated in FIG. 19, when the pinch-open gesture is recognized based on the distance between the two fingers, the higher a rate of increase in the distance between the two fingers becomes, the larger a determination of the pinch-open gesture becomes. Also, as illustrated in FIG. 21, when the pinch-open gesture is recognized based on an increase in the size of the gesture space, the higher a rate of increase in the size of the gesture space becomes, the larger the determination of the pinch-open gesture becomes.

Also, as illustrated in FIGS. 23A to 23D, when the pinch-open gesture is recognized based on the distance between the plurality of fingers and the center point C, the higher a rate of increase in the distance between the plurality of fingers and the center point C becomes, the larger the determination of the pinch-open gesture becomes.

The vehicle 1 determines the icon to be added based on the predetermined priority (S752). The icon to be added may be determined according to the predetermined priority list 451. That is, the icon corresponding to the menu having the high priority is first added.

For example, when the priority list 451 is set as illustrated in FIG. 6, the icons are added in an order of a voice recording icon 207 and an Internet icon 208 according to the priority of the menu.

The vehicle 1 displays the screen image, while the determined icon is added (S753). For example, when one icon is added, the screen image in which the voice recording icon 207 is added is displayed, as illustrated in FIG. 24A, and when two icons are added, the screen image in which the voice recording icon 207 and the Internet icon 208 are added is displayed, as illustrated in FIG. 24B.

Meanwhile, a size or an arrangement of the icon may be controlled in response to the adding of the icon.

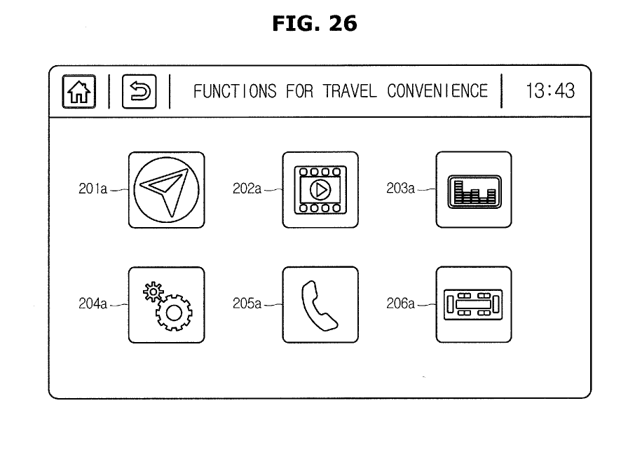

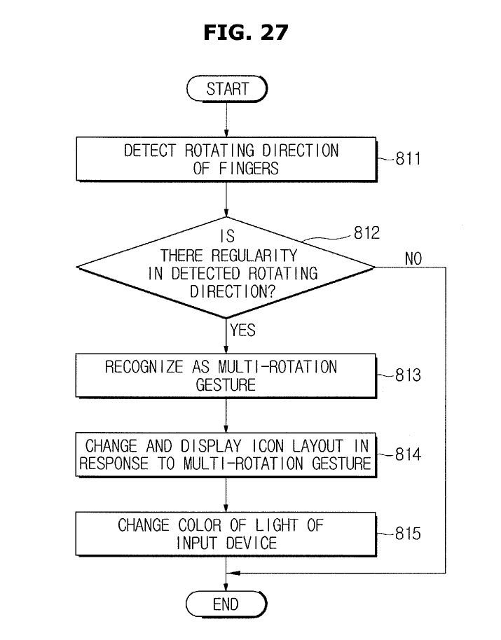

FIG. 26 is a view illustrating a change in the screen image of the display part 200 according to a recognition of a multi-rotation gesture, and FIG. 27 is a flowchart illustrating a method of recognizing the pinch-close gesture.

The gesture recognizer 410 may recognize the multi-rotation gesture illustrated in FIG. 9, and may control the display part 200 so that an icon layout of the display part 200 is changed corresponding to the multi-rotation gesture.

Referring to FIG. 27, the vehicle 1 detects a rotation direction of the fingers (S811). The gesture recognizer 410 analyzes a change in positions of the fingers, and detects the rotation direction of each finger.

The vehicle 1 determines whether or not there is regularity in the detected rotation direction (S812). That is, the gesture recognizer 410 determines whether or not the plurality of fingers are rotated in the same direction.

When it is determined that there is the regularity in the detected rotation direction (S812), the vehicle 1 recognizes the multi-rotation gesture (S813).

The vehicle 1 changes and displays the icon layout in response to the multi-rotation gesture (S814). The icon layout includes a color, a shape, a position, a size and an arrangement of the icon displayed on the display part 200. The icon layout displayed on the display part 200 may be changed by a control of the gesture recognizer 410.

For example, the shapes, the positions, the sizes and the arrangements of the icons 201a to 206a displayed on the display part 200 may be changed as illustrated in FIG. 26.

The vehicle 1 may change a color of light in the input device 100 (S815). For example, the light emitted from the input device 100 may become brighter, or the color of the light emitted from the input device 100 may be changed.

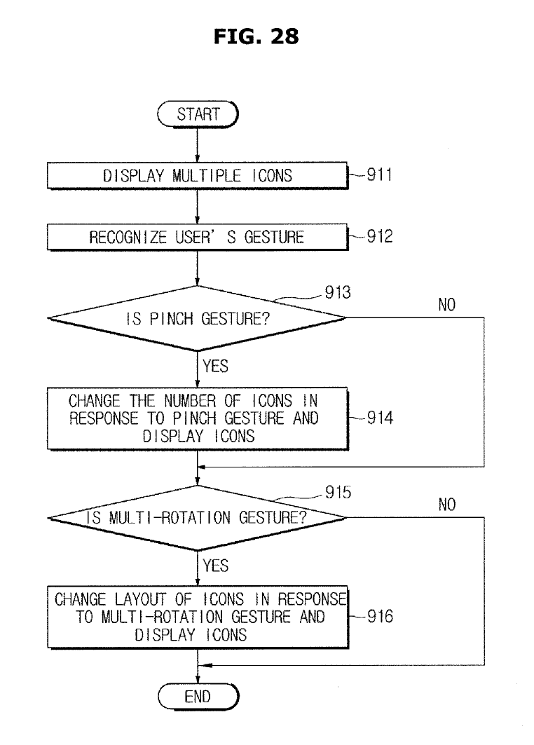

FIG. 28 is a view illustrating a method of controlling the vehicle 1.

Referring to FIG. 28, the vehicle 1 displays a plurality of icons (S911). The display part 200 displays the screen image including the plurality of icons. The user may control the functions of the vehicle 1 using the plurality of icons displayed on the display part 200, or may change the settings.

At this time, the number of icons displayed on the screen image may be determined according to a recognition result of the user's voice. For example, when the user says “six”, six icons may be displayed on the display part 200, as illustrated in FIG. 5.

The vehicle 1 recognizes a user's gesture (S912). The vehicle 1 may detect a change in the positions of the user's fingers, and may recognize the gesture input by the user based on the detected change in the positions of the user's fingers.

The vehicle 1 determines whether or not the recognized user's gesture is a pinch gesture (S913). Specifically, the vehicle 1 may determine whether or not the user's gesture is the pinch-close gesture in which the user's hand is cupped or the pinch-open gesture in which the user's hand is opened.

When it is determined that the recognized gesture is the pinch gesture, the vehicle 1 changes the number of icons in response to the pinch gesture, and then displays the icons (S914). Specifically, the display part 200 displays the screen image in which the number of icons is reduced as illustrated in FIGS. 16A and 16B in response to the pinch-close gesture.

And the display part 200 displays the screen image in which the number of icons is increased as illustrated in FIGS. 24A and 24C in response to the pinch-open gesture.

At this time, the number of icons to be deleted or added may be determined according to a size of the pinch gesture input by the user. The icons to be deleted or added may be determined by the priority list 451.

The vehicle 1 determines whether or not the recognized user's gesture is the multi-rotation gesture (S915).

When it is determined that the recognized user's gesture is the multi-rotation gesture, the vehicle 1 changes and displays the icon layout (S916). The display part 200 may change and display the color, the shape, the position, the size, and the arrangement of the icon in response to the user's multi-rotation gesture.

As described above, the number and the layout of the icons displayed on the display part 200 may be changed based on the user's gesture, and thus it is possible to provide an interface corresponding to a user's taste.

The user can personalize the user interface using the gesture. Specifically, the user can dynamically adjust the number of the displayed icons using the pinch gesture, and the user interface can be optimized according to a traveling situation.

Also, the user can dynamically adjust the layout of the icons using the multi-rotation gesture, and the user interface can be optimized according to the traveling situations.

Although a few embodiments of the present disclosure have been shown and described, it would be appreciated by those skilled in the art that changes may be made in these embodiments without departing from the principles and spirit of the disclosure, the scope of which is defined in the claims and their equivalents. All such changes should be construed to fall within the scope of the disclosure. Accordingly, the embodiments and method disclosed should be considered from a descriptive point of view and are not for the purposes of limitation.

What is claimed is:

1. An input device comprising:
a gesture interface configured to receive an input of a user's gesture;
a display unit configured to display a plurality of icons; and
a control unit configured to recognize the user's gesture, and to control the display unit to change the number of icons to be displayed when the recognized gesture is a pinch gesture.

2. The input device according to claim 1, wherein the display unit is configured to reduce the number of icons to be displayed in response to a pinch-close gesture in which a hand is cupped.

3. The input device according to claim 2, wherein the control unit is configured to detect a change in a distance between two fingers, and recognize as the pinch-close gesture when the distance between the two fingers is reduced.

4. The input device according to claim 2, wherein the control unit is configured to detect a change in a size of a gesture space formed by a plurality of fingers, and recognize as the pinch-close gesture when the size of the gesture space is reduced.

5. The input device according to claim 4, wherein the control unit is configured to form the gesture space by connecting end points of the plurality of fingers.

6. The input device according to claim 1, wherein the display unit is configured to increase the number of icons to be displayed in response to a pinch-open gesture in which a hand is opened.

7. The input device according to claim 6, wherein the control unit is configured to detect a change in a distance between two fingers, and recognize as the pinch-open gesture when the distance between the two fingers is increased.

8. The input device according to claim 6, wherein the control unit is configured to detect a change in a size of a gesture space formed by a plurality of fingers, and recognize as the pinch-open gesture when the size of the gesture space is increased.

9. The input device according to claim 1, wherein the gesture interface comprises a touch interface configured to detect an input of a user's touch, and
the control unit is configured to detect a change in positions of a plurality of fingers using touch coordinates detected by the touch interface, and recognize the user's gesture based on the change in the positions of the plurality of fingers.

10. The input device according to claim 9, wherein the touch interface further comprises a center point, and the control unit is configured to recognize the user's gesture based on a change in an average distance between the plurality of fingers and the center point.

11. The input device according to claim 10, wherein the control unit is configured to recognize as a pinch-close gesture when the distance between the plurality of fingers and the center point is reduced, and also recognize as a pinch-open gesture when the average distance between the plurality of fingers and the center point is increased.

12. The input device according to claim 1, wherein the gesture interface further comprises a space interface configured to obtain an image of the user and thus to receive an input of a user's space gesture, and
the control unit is configured to detect a plurality of fingers from the image, analyze changes in positions of the plurality of fingers, and recognize the user's gesture based on the changes in the positions of the plurality of fingers.

13. The input device according to claim 1, wherein the display unit is configured to change a layout of the plurality of icons to be displayed in response to a multi-rotation gesture in which a hand is rotated.

14. The input device according to claim 13, wherein an icon layout comprises at least one of colors, shapes, positions, sizes, and arrangements of the plurality of icons.

15. The input device according to claim 9, wherein the touch interface is configured to change a color of emitted light in response to a multi-rotation gesture in which a hand is rotated.

16. The input device according to claim 1, wherein the control unit is configured to determine the number of icons to be changed based on a size of the pinch gesture.

17. The input device according to claim 16, wherein the control unit is configured to determine the icons to be displayed on the display unit based on an order of priority stored in a priority list stored in advance.

18. A method of controlling an input device, comprising:
displaying a plurality of icons;
recognizing a user's gesture on the input device; and
changing the number of icons to be displayed in response to the user's gesture when the recognized gesture is a pinch gesture.

19. The method according to claim 18, wherein changing the number of icons comprises reducing the number of icons to be displayed when the recognized gesture is a pinch-close gesture in which a hand is cupped.

20. The method according to claim 19, wherein recognizing a user's gesture comprises detecting a change in a distance between two fingers, and recognizing as the pinch-close gesture when the distance between the two fingers is reduced.

21. The method according to claim 19, wherein recognizing a user's gesture comprises determining a size of a gesture space formed by end points of a plurality of fingers, and recognizing as the pinch-close gesture when a size of the gesture space is reduced.

22. The method according to claim 19, wherein recognizing a user's gesture comprises calculating an average distance between a plurality of fingers and a predetermined center point, and recognizing as the pinch-close gesture when the average distance between the plurality of fingers and the predetermined center point is reduced.

23. The method according to claim 19, wherein changing the number of icons comprises increasing the number of icons to be displayed when the recognized gesture is a pinch-open gesture in which a hand is opened.

24. The method according to claim 23, wherein recognizing a user's gesture comprises detecting a change in a distance between two fingers, and recognizing as the pinch-open gesture when the distance between the two fingers is increased.

25. The method according to claim 23, wherein recognizing a user's gesture comprises detecting a size of a gesture space formed by end points of a plurality of fingers, and recognizing as the pinch-open gesture when the size of the gesture space is increased.

26. The method according to claim 23, wherein recognizing a user's gesture comprises calculating an average distance between a plurality of fingers and a predetermined center point, and recognizing as the pinch-open gesture when the distance between the plurality of fingers and the predetermined center point is increased.

27. The method according to claim 18, further comprising changing a layout of the plurality of icons to be displayed in response to a multi-rotation gesture in which a hand is rotated.

28. The method according to claim 18, further comprising changing a color of light of a gesture interface in response to a multi-rotation gesture in which a hand is rotated.

29. The method according to claim 18, wherein recognizing a user's gesture comprises detecting changes in positions of a plurality of fingers using touch coordinates detected by a touch interface.
